(19) United States
(12) Patent Application Publication
(10) Pub. No.: US 2023/0188591 A1
(43) Pub. Date: Jun. 15, 2023

(54) RECORDER FOR WEBGUI APPLICATION

(71) Applicant: SAP SE, Walldorf (DE)

(72) Inventors: Satyadeep Dey, Bangalore (IN); Vinay Kumar, Bangalore (IN); Sharmika Parmar, Walldorf (DE); Sudha Karanam Narasimha Murthy, Walldorf (DE); Chandrakanth S, Walldorf (DE); Mithilesh Kumar Singh, Ara (IN); Suvajit Dutta, Walldorf (DE); Arno Esser, Walldorf (DE)

(21) Appl. No.: 17/550,263

(22) Filed: Dec. 14, 2021

(51) Int. Cl. H04L 67/01; H04L 67/141; H04L 67/143; H04L 67/02; H04L 41/22

(52) U.S. Cl. CPC H04L 67/42; H04L 67/141; H04L 67/143; H04L 67/02; H04L 41/22

(57) ABSTRACT

Provided are systems and methods for recording user interface events that occur in a software application developed via a WebGUI framework. In one example, a method may include establishing a session between a front-end of a web application open within a web browser on a client device and a back-end of the web application hosted on a server, activating a recorder via a web extension of the web browser of the client device based on attributes of the established session, capturing user interface events transmitted between the front-end of the application within the web browser on the client device and the back-end of the application hosted on the server via the activated recorder, and recording the captured user interface events in a file.

### BACKGROUND

WebGUI, also referred to as WEBGUI and SAP GUI for hypertext markup language (HTML), is an implementation model for screen-based software applications that allows users to run dialog transactions directly in a web browser. WebGUI may dynamically provide user interfaces/screens in the web browser for transactional processing such as entering data into fields, opening pages, moving a cursor, clicking buttons, checking boxes, and the like. WebGUI relies on a client-server architecture in which a client-side or front-end of an application communicates with a server-side or back-end of the application to render content within a graphical user interface at the front-end.

Recently, robotic processing automation (RPA) has gained attention for its ability to create bot programs that can perform automated user interface actions on a user interface of a software application (e.g., a WebGUI-based application, etc.) in place of a user. For example, a bot program can automatically read data, enter the data, submit data, check boxes and buttons, make other selections, open pages, click on links, and the like. However, creating such bot programs typically requires a significant amount of manual intervention by a user.

### BRIEF DESCRIPTION OF THE DRAWINGS

Features and advantages of the example embodiments, and the manner in which the same are accomplished, will become more readily apparent with reference to the following detailed description while taken in conjunction with the accompanying drawings.

FIG. 1A is a diagram illustrating a computing environment for application development in accordance with an example embodiment.

FIG. 1B is a diagram illustrating a process of recording communications via the computing environment of FIG. 1A, in accordance with an example embodiment.

FIG. 2A is a diagram illustrating a user interface of a software application in accordance with an example embodiment.

FIG. 2B is a diagram illustrating an event that is submitted to initiate recording of the WebGUI application in accordance with an example embodiment.

FIG. 3 is a diagram illustrating a process of recording a sequence of events as they are performed via a user interface in accordance with an example embodiment.

FIG. 4 is a diagram illustrating a reproduction of a recorded sequence of events in accordance with an example embodiment.

FIG. 5 is a diagram illustrating a method for recording user interface events of an application in accordance with an example embodiment.

FIG. 6 is a diagram illustrating a computing system for use with any of the examples herein in accordance with an example embodiment

Throughout the drawings and the detailed description, unless otherwise described, the same drawing reference numerals will be understood to refer to the same elements, features, and structures. The relative size and depiction of these elements may be exaggerated or adjusted for clarity, illustration, and/or convenience.

### DETAILED DESCRIPTION

In the following description, specific details are set forth in order to provide a thorough understanding of the various example embodiments. It should be appreciated that various modifications to the embodiments will be readily apparent to those skilled in the art, and the generic principles defined herein may be applied to other embodiments and applications without departing from the spirit and scope of the disclosure. Moreover, in the following description, numerous details are set forth for the purpose of explanation. However, one of ordinary skill in the art should understand that embodiments may be practiced without the use of these specific details. In other instances, well-known structures and processes are not shown or described in order not to obscure the description with unnecessary detail. Thus, the present disclosure is not intended to be limited to the embodiments shown, but is to be accorded the widest scope consistent with the principles and features disclosed herein.

Intelligent robotic process automation uses intelligent software bots to automate repetitive manual-based processes that are performed via a computer. For example, a process of a user entering data values into fields of a user interface of a software application may be replaced with an automated bot. That is, rather than a human reading data from a source or multiple sources and entering them into fields of a user interface, a bot can be programmed to perform the same process automatically. Some of the benefits of the bot include systematizing time-consuming manual activities which significantly increase the speed at which such processes are performed. Furthermore, bots remove the possibility of human error in the data entry thereby ensuring that the data being entered is correct. Bots can open applications, click buttons, set values, close windows, etc. Furthermore, a bot can be programmed to open database tables, read values at specific locations in the tables, store values, etc.

As an example, the software application may be a WebGUI application such as an SAP GUI for HTML application. WebGUI relies on a client-server architecture in which a client-side or front-end of a software application communicates with a server-side or back-end of the software application to render content within a graphical user interface on the client-side. WebGUI is one of the Internet Transaction Server (ITS) implementation models for screen-based applications that allow users to run SAP dialog transactions directly from a Web browser, the other two models including SAP GUI for Windows and SAP GUI for Java. This model automatically maps the screen elements in SAP transactions to HTML using HTML^{Business} functions implemented inside the ITS. Each HTML^{Business} function handles a different screen element and uses the screen attributes to position HTML controls at the same position on the HTML page as on the system screen. With WebGUI, the user interacting with the screen needs little or no knowledge of HTML, HTML^{Business}, or JavaScript. Also, the user does not have to be familiar with the software development environment, because the WebGUI generates the required templates to automatically run a WebGUI application.

Here, the front-end of the application may detect user interface events and send requests for content to the back-end of the application with identifications of the detected user interface events including an ID of the user interface element where the event occurred, and a type of action (e.g., an action code) that is performed with respect to the user interface element. In response, the back-end can provide content corresponding to the detected user interface event for rendering in the user interface. For example, the content rendered by the server may include graphical user interface content such as modifications to images, buttons, data, and the like, which are visible within the user interface.

RESTGUI is a protocol that works as a bridge between a front-end of a WebGUI application (client-side) and a back-end of the WebGUI application (server-side). RESTGUI provides an interface/mechanism such as an application programming interface (API) which exposes the session between the client and the server and enables the web extension to subscribe to events at the back-end. Whenever a request comes in from the front-end of the WebGUI application, the request is sent as is to the backend. Here, the backend has an ITS layer that translates the data. The RESTGUI interface exposes a request/response mechanism between the client and the server such that the web extension can subscribe to specific events at the server and receive notifications of those events from the server. For example, the client can send a request directly to the backend with some special notations and they represent each control item with IDs, formatting, and the whole thing is readable at the server side because of this layer. In this example, the application may be displayed/posted in the web browser. The web extension is side-by-side with the web application logically.

The web extension of the example embodiments utilizes the interface provided by the REST GUI protocol to receive communications between the front-end and the back-end. The web extension may subscribe to events via the RESTGUI protocol using a window message (e.g., a Window.POST message). Here, an initial subscription tells the backend/REST GUI side to provide the web extension with the state/position data of UI controls that are interacted with by a user on the front-end of the application. Then every time a new event occurs associated with that data, the web extension is notified by the backend and the web extension may forward pass the events to a recorder widget that is hosted locally on the client-side. For example, a recording widget may be running as a desktop application/studio agent. The recording widget can record each user interface interaction on the front-end. The recording widget may also provide a window that lists the recorded events in the order they are detected.

In the example embodiments, a recorder widget can connect to a session between a front-end and a back-end of a WebGUI software application, capture and record the user interface actions on the front-end of the WebGUI application and the instructions that are sent to the back-end of the WebGUI application, record the responses from the server, and build a bot based on the recorded user interface actions. Furthermore, the example embodiments may translate the technical details of the WebGUI events (e.g., actions, action codes, etc.) into activity descriptions that are understandable to a person with little or no software development experience. For example, the system described herein may translate an identifier of a user interface element and an identifier of a type of action code performed on the user interface element into a human-readable description such as “Open Page”, “Set Value in Field”, “Submit Data to Backend”, etc.

The recorded events can be used to build a bot that can understand the WebGUI application and automatically perform various business contexts on the user interface of the front-end of the application. WebGUI refers to the user interface that is output on the screen, while RESTGUI refers to the mechanism/interface that exposes the session between the client and the server executing the WebGUI application. In some embodiments, the user interactions may be performed on the client side, while the instructions are executed on the server-side which has the logic there. The web extension may subscribe to events for the recorder from the server-side and the server-side can send notifications of events to the recorder as they occur in real-time. For example, the web extension can connect to the session between the front-end and the back-end via RESTGUI to capture user interactions on the user interface of the WebGUI application which can be stored in a file and exported to a development environment such as an integrated development environment (IDE) where the bot can quickly and easily be built in an automated manner.

Accordingly, the example embodiments use a REST GUI service to record the interactions between the front-end and the back-end of the WebGUI application. The REST GUI service provides recognition of the individual user interface controls (e.g., unique identifier of an input field, button, drop-down, etc.) This information then gets transferred into the language of the application and used for identification. Each field has a unique ID and its stored in the backend of the WebGUI application. Here, the REST GUI service/extension may consume a window object/metadata of the WebGUI application which provides the unique identifiers to UI element mappings. In this example, there may be a mapping between UI elements and IDs, and it knows what the front-end is trying to do based on the IDs.

When a client-side of a software application sends a user interface request to the server, the RESTGUI protocol follows the normal client-server relationship. The web extension may obtain and utilize content of a currently open page of the application in the session between the front-end and the back-end of the application. For example, the web extension may consume a window object (e.g., the DOM, etc.) where the user interface is rendered enabling the web extension to interpret the information included in the user interface requests sent to the server from the front-end of the application using the same window object. For example, the window object may identify user interface elements with unique IDs and also positioning information (pixel locations, etc.) of the user interface elements on the screen. The particular page rendering is done based on the server state information. The web extension then forward the events that are captured to the recorder where the events are stored for subsequent bot generation, etc.

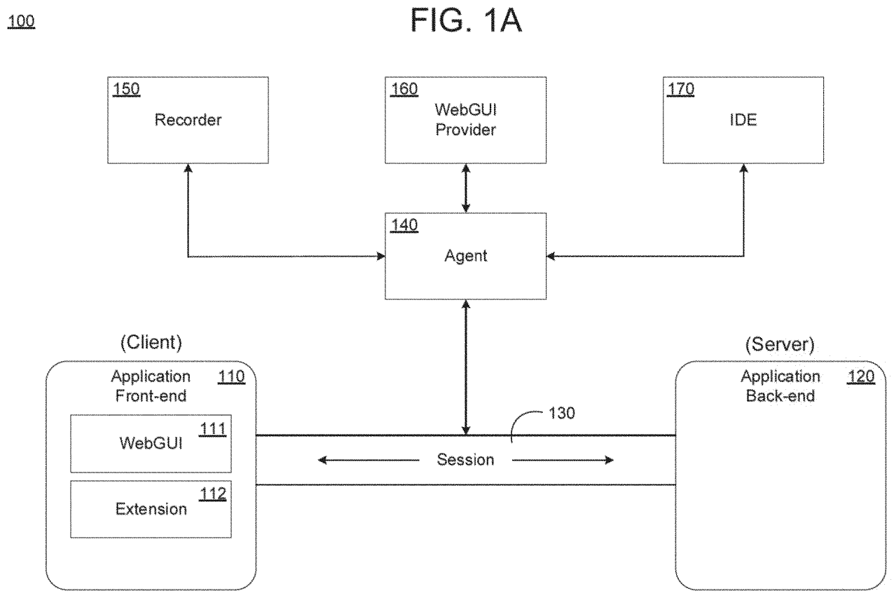

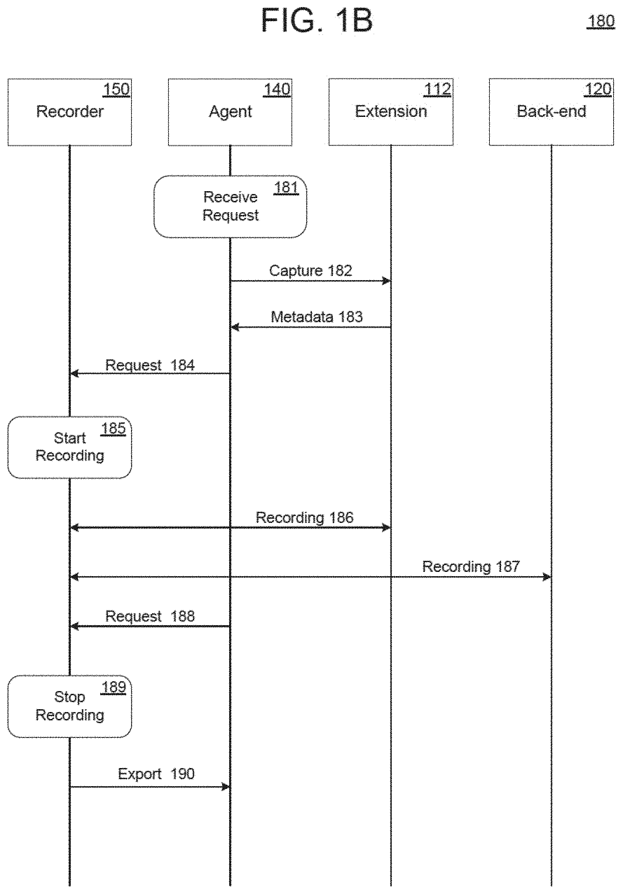

FIG. 1A illustrates a computing environment 100 for application development in accordance with an example embodiment. Referring to FIG. 1A, the computing environment 100 includes a software application (e.g., a WebGUI application, etc.) which includes a client-side or front-end 110 and a server-side or back-end 120 which communicate with each other via a session 130 (e.g., a web session, etc.) The session may be established via hypertext transfer protocol (HTTP) messages. In some embodiments, an authentication protocol may be performed between the front-end 110 and the back-end 120 to establish the session 130.

According to various embodiments, an agent 140 can be used to manage the recording process. Furthermore, a recorder 150 may be implemented locally on the client device and may connect to the session 130 via a web extension 112 within a browser of the client device where the front-end of the software application is running. The recorder 150 records user interactions that occur on the front-end 110 of the application and the responses from the back-end 120 of the application. In some embodiments, the requests/responses are captured via the session 130. As another example, the requests/responses can be provided from either the front-end 110 or the back-end 120.

The computing environment 100 also includes an integrated development environment (IDE) 170 that provides a complete bot development environment for creating and testing a bot. in some embodiments, the IDE 170 may be an IDE for cloud applications hosted on a cloud platform which is the server-side. In order to create a bot for automating a WebGUI application, the user first needs to capture the application from the IDE 170 and then launch the recorder 150 to record the user interactions on the user interface of the front-end 110 of the application. A WebGUI provider 160 may process the recorded user interface actions and application metadata and transform captured event information (e.g., action code, control details, position parameters, etc.) into bot-specific information (e.g., screens, activities, automation, etc. The recorder 150 may be a standard and generic recording universal recording widget that provides functionality to start recording, stop recording, export recording and view recorded step information. It also has features to undo, redo and delete steps.

Meanwhile, the agent 140 may be a hub that provides a central communication interface between the IDE 170, a WebGUI provider 160, the recorder 150, and the application (e.g., front-end 110 and the back-end 120) through a web extension 112 (e.g., CHROME® extension, etc.) The recorder 150 may be implemented via a web extension 112 that is integrated into the application itself through a WebGUI connector API. The web extension 112 may interact with the back-end 120 of the application using a WebGUI connector API 111. The recorder 150 may use the web extension 112 to capture screen shots and content, metadata, establish a connection, disconnection, record interactions, and the like. The WebGUI connector API 111 may define a common request/response j son structure and be implemented an asynchronous interface. The WebGUI connector API 111 provides an API for creating the connection, closing the connection, subscribing to events for recording, executing batch bot info, and the like. The web extension 112 may use these APIs to connect the recorder 150 to the application and subscribe to recording events and executing the automation.

In the example embodiments, the recorder 150 may utilize a “window object” where the UI is rendered and record requests to the server using the same window object. The web extension 112 is capable of utilizing the session where the page is open. The may send a request to the server using the same window object. Page rendering is done based on server state information. The server state can also be captured by the recorder. For example, the recorder may request that when a web browser opens a URL, requests to the server for this page should be recorded. Likewise, the content sent from the backend server to the front-end UI where it is rendered in the window may be recorded. The web extension 112 has the capability to sit beside the web application and have the visibility to see the window object and a document object model (DOM) via the web application. The DOM may include an API that defines the logical structure/layout of pages and documents (e.g., HTML, XML, etc.) and the way that the pages and documents are accessed and manipulated.

When a user clicks on a button via the UI on the front-end, a request is sent to the server. The server then responds with what needs to be rendered/content. The same thing happens with the recorder 150. Whenever a button is pressed on the UI, the application continues to send the request to the backend and the web extension 112 captures it and sends it to the recorder 150 via the agent 140.

The WebGUI connector API 111 used by the web extension 112 provides simple interfaces/APIs for connecting to a session and recording transactions running on a WebGUI application user interface. The WebGUI connector API 111 also provides APIs for capturing the current state of the WebGUI page and position of the UI elements/controls. These two APIs allow the web extension 112 to capture both the state of the page and the position of the actions/events and forward these to the recorder 150. Using these two pieces of information, the system can also reconstruct the events and build a bot. The recording of the application page may be performed via creation of a subscription.

FIG. 1B illustrates a process 180 of recording communications via the computing environment 100 of FIG. 1A, in accordance with an example embodiment. Referring to FIG. 1B, in 181, the agent 140 receives a request to start recording user interface events of a software application that includes the web extension 112. Here, the request may be received via the IDE 170 or via some other mechanism. In response, in 182, the agent 140 may trigger the web extension 112 to start capturing and forwarding user interface events to the recorder 150. In response, the web extension 112 may provide the agent 140 with application metadata in 183. The application metadata may include the window object, the DOM, etc., and may include mappings between unique identifiers of UI elements and the corresponding pages/locations of the UI elements within the application. In 184, the agent 140 forward the metadata to the recorder 150.

At 185, the recorder 150 starts recording. Here, the recorder 150 may record communications via the front-end 110 in 186 and/or via the back-end 120 in 187. Each user interface event sent from the front-end 110 of the application to the back-end 120 of the application may be recorded by the recorder 150. At some point, either by request of the IDE 170 or some other request, the agent 140 may request the recorder 150 to stop recording the page/website in 188. In 189, the recorder 150 may stop recording and in 190 the recorder 150 may export all recorded user interface events, content responses, etc. to the agent 140 which can then be forwarded to the IDE 170 for automated bot development.

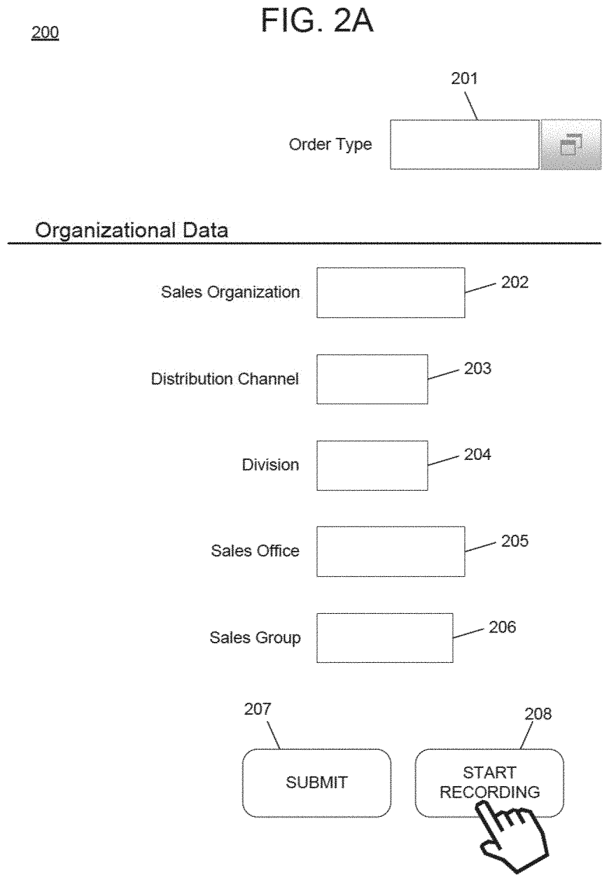

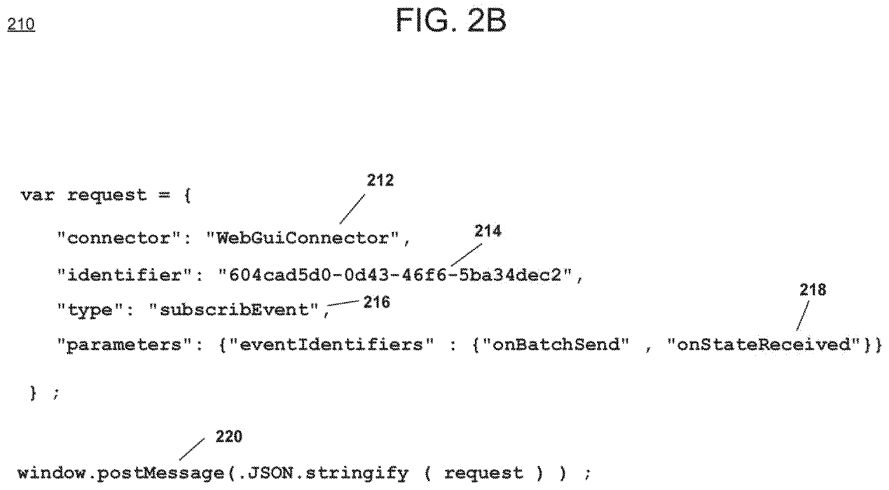

FIG. 2A illustrates a user interface 200 of a WebGUI application in accordance with an example embodiment, and FIG. 2B illustrates an event 210 that is submitted by the extension to the server-side of the application to initiate recording of the WebGUI application in accordance with an example embodiment. Referring to FIG. 2A, the user interface 200 includes a plurality of fields 201, 202, 203, 204, 205, and 206 for data entry. Each field 201-206 includes an identifier displayed to the left of the respective field which identifies the type of data to be entered into the respective field.

The user interface 200 may be used by a user to repetitive enter and send data to the server where it can be stored in a table of a database, an OData service, or the like. The user interface 200 also includes a submit button 207 to submit the data values that have been added to the fields 201-206 of the user interface 200. The user interface 200 also includes a start recording button 208. When pressed, the start recording button 208 may be detected by the agent which triggers the recorder to start working.

Referring to FIG. 2B, the event 210 includes various attributes including an identifier of the API 212 used to connect to the application, an identifier of the event 214, an identifier of the type of subscription 216 that is desired by the extension, and the parameters 218. The subscription parameter is an “OnBatchSend” parameter. Once this request is received by the server, all of the interactions/events on the UI are recorded by the recorder which in this case is implemented with a RESTGUI service. The event 210 is sent via the Web Connector API from the extension to the server. This request uses a parameter to identify the type of event (e.g., “OnBatchSend”). This will look for any events that happen on the page in the UI. This lets the server know the recorder is interested in capturing events from the user interface. The web extension does not know where it is located. It could be on the server or on the client. Furthermore, the “onStateReceived” parameter specifies that the recorder wants to record the content that is provided by the server in response to the user interactions on the user interface of the front-end of the application.

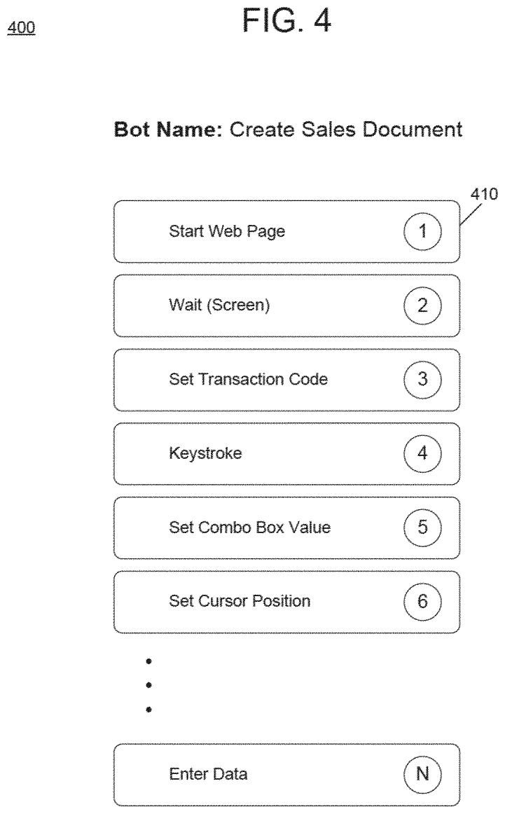

The recorder collects all of these events, then parses and transforms the events into high-level activities. The events can be ordered into a list such as shown in the list 400 of FIG. 4. The list 400 includes a sequence of steps 410 that are performed on the user interface and then translated by the service that implements the recorder. In response, a list of all the actions that are performed on the UI and the order in which the actions are performed are provided via the list 400. The application already has a session with the server and it has a window object that can be used to pass information to the server. Furthermore, the post message 220 at the bottom specifies the window/web browser of the session and also the window object that is to be returned from the extension of the application.

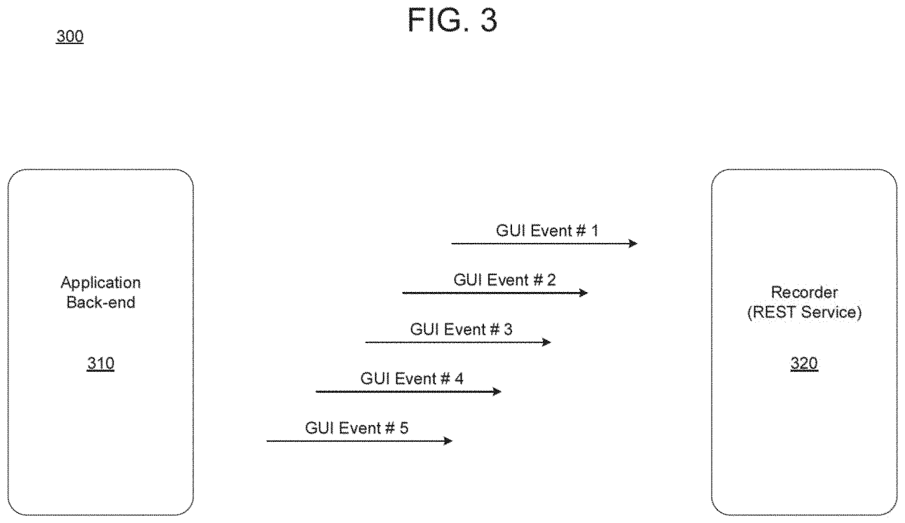

FIG. 3 illustrates a process 300 of recording a sequence of events as they are performed via a user interface of an application in accordance with an example embodiment. Referring to FIG. 3, a recorder 320 has been activated. In this case, the GUI events that are performed on the user interface of a front-end of an application are sent to a back-end 310 of the application. Each GUI event is captured by the recorder 320 of the present application via a service that connects to the back-end 310 or to a session between the front-end and the back-end 310 via a API. The API (e.g., WebGUI Connector API, etc.) enables the application to specify the application to be recorded and receive metadata of the application. This metadata can be consumed by the service/recorder and used to interpret the commands that are sent from the front-end to the back-end 310 of the application.

Each GUI event may include a unique identifier of a GUI element such as a radio button, a combo box, a text input field, a menu, a checkbox, etc. It should also be appreciated that the GUI events may include other attributes such as focus information, cursor position information, data entry values, content, and the like. The service can interpret these events based on the window object/metadata of the application that are consumed. Furthermore, the events may be recorded, ordered, and then displayed in the form of the list 400 shown in FIG. 4.

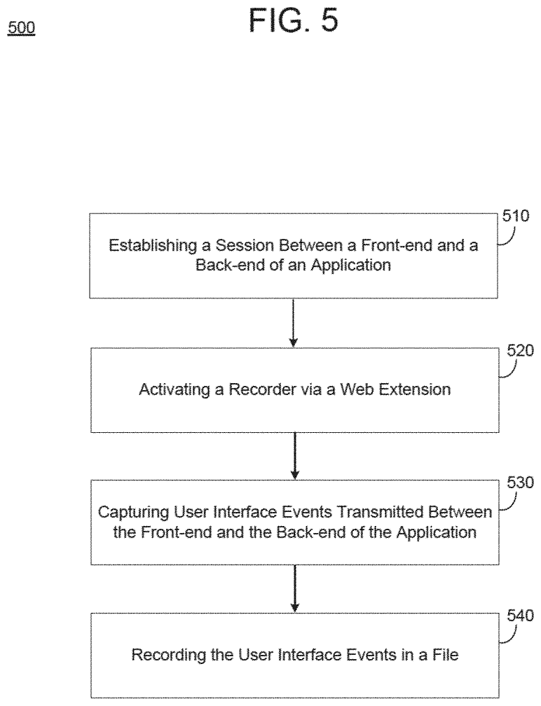

FIG. 5 illustrates a method 500 for recording user interface events of an application in accordance with an example embodiment. As an example, the method 500 may be performed by a cloud platform, a web server, an on-premises server, a user device, a combination of devices, and the like. The method 500 may be an automated method that is performed by a software application. In other words, the commands may be predefined and issued by the software application during an automated recording process.

Referring to FIG. 5, in 510, the method may include establishing a session between a front-end of a web application open within a web browser on a client device and a back-end of the web application hosted on a server. In some embodiments, the front-end of the application may be running on a user device such as a desktop computer, a laptop, a mobile device, a server, and the like. Meanwhile, the back-end of the application may be hosted on a server, cloud platform, database, etc., which is connected to the user device via a network such as the Internet.

In 520, the method may include activating a recorder via a web extension of the web browser of the client device based on attributes of the established session. In 530, the method may include capturing user interface events transmitted between the front-end of the application within the web browser on the client device and the back-end of the application hosted on the server via the activated recorder. In 540, the method may include recording the captured user interface events in a file.

In some embodiments, the activating may include transmitting an activation request to the server which identifies the web extension and identifies events that are to be recorded. In some embodiments, the activating may include transmitting a call via an application programming interface (API) of the web extension to the server. In some embodiments, the web extension may include a representational state transfer (REST) graphical user interface (GUI) service that communicates with the server via a set of APIs.

In some embodiments, the capturing may further include capturing content to be rendered on the front-end of the application transmitted from the server in response to the user interface events, and recording the captured content within the file. In some embodiments, the recording may include recording unique identifiers of user interface elements that are interacted with during the session, and an order in which the identifiers of the user interface elements are interacted with during the session. In some embodiments, the activating may include activating the recorder in response to a user input via the web browser of the client device. In some embodiments, the method may further include terminating the recorder and exporting the captured user interface events in the file to a bot creation software program.

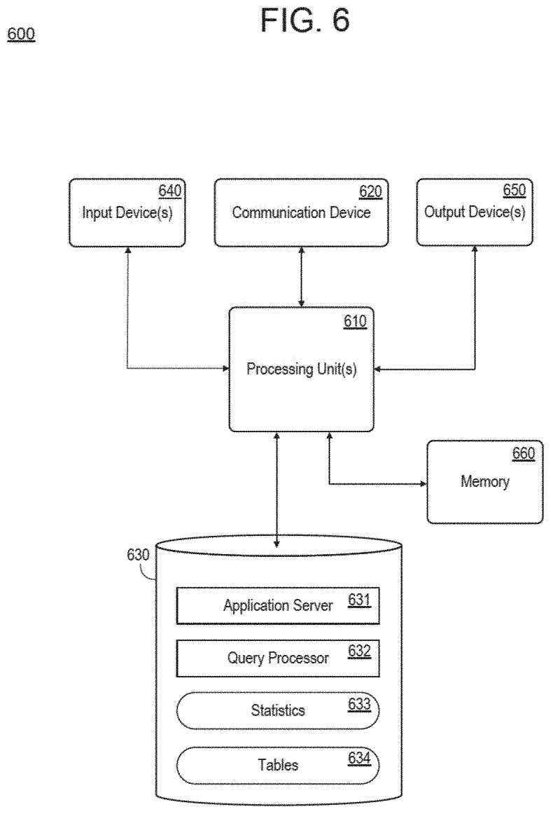

FIG. 6 is a diagram of a server node 600 according to some embodiments. The server node 600 may include a general-purpose computing apparatus and may execute program code to perform any of the functions described herein. The server node 600 may comprise an implementation of a remote terminal or a host platform, in some embodiments. It should also be appreciated that the server node 600 may include other unshown elements according to some embodiments and may not include all of the elements shown in FIG. 6.

Server node 600 includes processing unit(s) 610 (i.e., processors) operatively coupled to communication device 620, data storage device 630, input device(s) 640, output device(s) 650, and memory 660. Communication device 620 may facilitate communication with external devices, such as an external network or a data storage device. Input device(s) 640 may comprise, for example, a keyboard, a keypad, a mouse or other pointing device, a microphone, knob or a switch, an infra-red (IR) port, a docking station, and/or a touch screen. Input device(s) 640 may be used, for example, to enter information into the server node 600. Output device(s) 650 may comprise, for example, a display (e.g., a display screen) a speaker, and/or a printer.

Data storage device 630 may comprise any appropriate persistent storage device, including combinations of magnetic storage devices (e.g., magnetic tape, hard disk drives and flash memory), optical storage devices, Read Only Memory (ROM) devices, etc., while memory 660 may comprise Random Access Memory (RAM). In some embodiments, the data storage device 630 may store user interface elements in tabular form. For example, one or more columns and one or more rows of user interface elements may be displayed in a two-dimensional spreadsheet, table, document, digital structure, or the like.

Application server 631 and query processor 632 may each comprise program code executed by processing unit(s) 610 to cause server node 600 to perform any one or more of the processes described herein. Such processes may include estimating selectivities of queries on tables 634 based on statistics 633. Embodiments are not limited to execution of these processes by a single computing device. Data storage device 630 may also store data and other program code for providing additional functionality and/or which are necessary for operation of server node 600, such as device drivers, operating system files, etc.

As will be appreciated based on the foregoing specification, the above-described examples of the disclosure may be implemented using computer programming or engineering techniques including computer software, firmware, hardware or any combination or subset thereof. Any such resulting program, having computer-readable code, may be embodied or provided within one or more non transitory computer-readable media, thereby making a computer program product, i.e., an article of manufacture, according to the discussed examples of the disclosure. For example, the non-transitory computer-readable media may be, but is not limited to, a fixed drive, diskette, optical disk, magnetic tape, flash memory, external drive, semiconductor memory such as read-only memory (ROM), random-access memory (RAM), and/or any other non-transitory transmitting and/or receiving medium such as the Internet, cloud storage, the Internet of Things (IoT), or other communication network or link. The article of manufacture containing the computer code may be made and/or used by executing the code directly from one medium, by copying the code from one medium to another medium, or by transmitting the code over a network.

The computer programs (also referred to as programs, software, software applications, “apps”, or code) may include machine instructions for a programmable processor, and may be implemented in a high-level procedural and/or object-oriented programming language, and/or in assembly/machine language. As used herein, the terms “machine-readable medium” and “computer-readable medium” refer to any computer program product, apparatus, cloud storage, internet of things, and/or device (e.g., magnetic discs, optical disks, memory, programmable logic devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal that may be used to provide machine instructions and/or any other kind of data to a programmable processor.

The above descriptions and illustrations of processes herein should not be considered to imply a fixed order for performing the process steps. Rather, the process steps may be performed in any order that is practicable, including simultaneous performance of at least some steps. Although the disclosure has been described in connection with specific examples, it should be understood that various changes, substitutions, and alterations apparent to those skilled in the art can be made to the disclosed embodiments without departing from the spirit and scope of the disclosure as set forth in the appended claims.

1. A computing system comprising:
a processor configured to
establish a session between a front-end of a web application open within a web browser on a client device and a back-end of the web application hosted on a server and expose an application programming interface (API) in association with the session,
activate a recorder via a web extension of the web browser of the client device based on attributes of the established session,
subscribe, via the web extension, to one or more types of user interface events via the exposed API;
capture, by the activated recorder, user interface events transmitted between the front-end of the application within the web browser on the client device and the back-end of the application hosted on the server via the exposed API based on the subscription, and
record data about the captured user interface events in a file via the recorder.

2. The computing system of claim 1, wherein the processor is configured to transmit an activation request to the server which identifies the web extension and identifies which types of user interface events that are to be recorded.

3. The computing system of claim, wherein the processor is configured to transmit a call to the server via the API with a request for the metadata.

4. The computing system of claim 1, wherein the web extension comprises a representational state transfer (REST) graphical user interface (GUI) service that communicates with the server via a set of APIs.

5. The computing system of claim 1, wherein the processor is configured to identify content to be rendered on the front-end of the application transmitted from the server in response to the user interface events and the obtained metadata, and record the identified content within the file.

6. The computing system of claim 1, wherein the processor is configured to record unique identifiers of user interface elements that are interacted with during the session, and a sequential order in which the identifiers of the user interface elements are interacted with during the session.

7. The computing system of claim 1, wherein the processor is configured to activate the recorder in response to a user input via the web browser of the client device.

8. The computing system of claim 1, wherein the processor is further configured to terminate the recorder and export the sequence of activities performed on the user interface to a bot creation software program.

9. A method comprising:
establishing a session between a front-end of a web application open within a web browser on a client device and a back-end of the web application hosted on a server and exposing an application programming interface (API) in association with the session;
activating a recorder via a web extension of the web browser of the client device based on attributes of the established session;
subscribing, via the web extension, to one or more types of user interface events via the exposed API;
capturing user interface events transmitted between the front-end of the application within the web browser on the client device and the back-end of the application hosted on the server via the activated recorder via the exposed API based on the subscription; and
recording data about the captured user interface events in a file.

10. The method of claim 9, wherein the activating comprises transmitting an activation request to the server which identifies the web extension and identifies which types of user interface events that are to be recorded.

11. The method of claim 9, wherein the activating comprises transmitting a call to the server via the API with a request for the metadata.

12. The method of claim 9, wherein the web extension comprises a representational state transfer (REST) graphical user interface (GUI) service that communicates with the server via a set of APIs.

13. The method of claim 9, wherein the capturing further comprises identifying content to be rendered on the front-end of the application transmitted from the server in response to the user interface events and the obtained metadata, and recording the identified content within the file.

14. The method of claim 9, wherein the recording comprises recording unique identifiers of user interface elements that are interacted with during the session, and a sequential order in which the identifiers of the user interface elements are interacted with during the session.

15. The method of claim 9, wherein the activating comprises activating the recorder in response to a user input via the web browser of the client device.

16. The method of claim 9, wherein the method further comprises terminating the recorder and exporting the sequence of activities performed on the user interface to a bot creation software program.

17. A non-transitory computer-readable storage medium comprising instructions which when executed by a processor cause a computer to perform a method comprising:
establishing a session between a front-end of a web application open within a web browser on a client device and a back-end of the web application hosted on a server and exposing an application programming interface (API) in association with the session;
activating a recorder via a web extension of the web browser of the client device based on attributes of the established session;
subscribing, via the web extension, to one or more types of user interface events via the exposed API;
capturing user interface events transmitted between the front-end of the application within the web browser on the client device and the back-end of the application hosted on the server via the activated recorder via the exposed API based on the subscription; and
recording data about the captured user interface events in a file.

18. The non-transitory computer-readable medium of claim 17, wherein the activating comprises transmitting an activation request to the server which identifies the web extension and identifies which types of user interface events that are to be recorded.

19. The non-transitory computer-readable medium of claim 17, wherein the activating comprises transmitting a call to the server via the API with a request for the metadata.

20. The non-transitory computer-readable medium of claim 17, wherein the web extension comprises a representational state transfer (REST) graphical user interface (GUI) service that communicates with the server via a set of APIs.
